(19) United States
(12) Patent Application Publication
(10) Pub. No.: US 2013/0325612 A1
(43) Pub. Date: Dec. 5, 2013

(54) METHODS AND SYSTEMS FOR INTERFACING E-COMMERCE PLATFORMS WITH BRICK AND MORTAR PRESENCES

(71) Applicant: WebLinc LLC, Philadelphia, PA (US)

(72) Inventors: Andrew SOMMERVILLE, Philadelphia, PA (US); Pavel NOVIK, Feasterville, PA (US); Daniel BAKER, Pottstown, PA (US); Eric BIGLER, Glen Mills, PA (US); Darren HILL, Jenkintown, PA (US); James VAN ARSDALE, Philadelphia, PA (US)

(21) Appl. No.: 13/909,581

(22) Filed: Jun. 4, 2013

Related U.S. Application Data
(60) Provisional application No. 61/655,293, filed on Jun. 4, 2012.

(51) Int. Cl. G06Q 30/02

(52) U.S. Cl. CPC G06Q 30/0259
USPC 705/14.57

(57) ABSTRACT

A method of integrating a retailer's E-Commerce and Point of Sale presences is described. A database of shopper profiles is populated by a first server. The shopper profiles correspond to a plurality of shoppers. Each shopper profile corresponds to one or more shoppers accessing the retailer's E-Commerce presence over a first network. A geolocation of a first mobile device having an application that is associated with the retailer is identified. The mobile device is associated with a first shopper from the plurality of shoppers. A second server determines that the first shopper is geographically proximate to a brick and mortar presence associated with the retailer based on the identified geolocation. A promotion for the first customer redeemable while the first customer is at the retailer's brick and mortar presence is selected. A third server transmits the selected promotion to the mobile device of the first customer over a second network.

### CROSS-REFERENCE TO RELATED APPLICATIONS

This application claims the benefit of U.S. Provisional Patent Application No. 61/655,293, filed on Jun. 4, 2012, entitled, “METHODS AND SYSTEMS FOR INTERFACING E-COMMERCE PLATFORMS WITH BRICK AND MORTAR PRESENCES”, the entire contents of which are incorporated herein by reference in their entirety.

### BACKGROUND OF THE INVENTION

In many industries, it is common for retailers to have both an E-Commerce presence and a brick and mortar presence. An E-Commerce presence affords the retailer an opportunity to display and sell a large number of goods, all of which typically cannot be stocked in a single brick and mortar location. The E-Commerce presence is typically accessed through a website or a mobile application on a computing device, such as a laptop computer, or a mobile device, such as a mobile smartphone or tablet computer.

Platforms for enabling a retailer's E-Commerce presence are capable of tracking retail inventory, as well as customer views, favorite items, preferences, purchases, and the like in a shopper profile. However, when the shopper visits a brick and mortar presence that is associated with the retailer's E-Commerce presence, the shopper typically cannot be easily identified and the

E-Commerce shopper profile of the shopper is not accessible while the shopper is physically at the brick and mortar presence.

Therefore, it is desirable to identify a shopper while the shopper is physically within a retailer's brick and mortar presence. It is further desirable to improve a shopper's in-store experience based on the shopper's E-Commerce shopper profile.

### BRIEF SUMMARY OF THE INVENTION

In one embodiment, a method of integrating a retailer's E-Commerce and Point of Sale presences is described. A database of shopper profiles is populated by a first server. The shopper profiles correspond to a plurality of shoppers. Each shopper profile corresponds to one or more shoppers accessing the retailer's E-Commerce presence over a first network. A geolocation of a first mobile device having an application that is associated with the retailer is identified. The mobile device is associated with a first shopper from the plurality of shoppers. A second server determines that the first shopper is geographically proximate to a brick and mortar presence associated with the retailer based on the identified geolocation. A promotion for the first customer redeemable while the first customer is at the retailer's brick and mortar presence is selected. A third server transmits the selected promotion to the mobile device of the first customer over a second network.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1 is a system diagram of an integrated system having an E-Commerce platform, a mobile consumer application and a point of sale application in accordance with a preferred embodiment of this invention;

FIG. 2 is an exemplary promotion notification in accordance with an embodiment of the present invention;

FIG. 3 is an exemplary consumer application store location screen in accordance with an embodiment of the present invention;

FIG. 4 is an exemplary consumer application promotion notification screen in accordance with an embodiment of the present invention;

FIG. 5 is an exemplary consumer application home screen in accordance with an embodiment of the present invention;

FIG. 6 is an exemplary consumer application home screen in accordance with another embodiment of the present invention;

FIG. 7 is an exemplary consumer application product information screen in accordance with an embodiment of the present invention; and

FIG. 8 is an exemplary consumer application review screen in accordance with an embodiment of the present invention.

### DETAILED DESCRIPTION OF THE INVENTION

Certain terminology is used in the following description for convenience only and is not limiting. The words “right,” “left,” “lower” and “upper” designate directions in the drawings to which reference is made. The terminology includes the words above specifically mentioned, derivatives thereof and words of similar import.

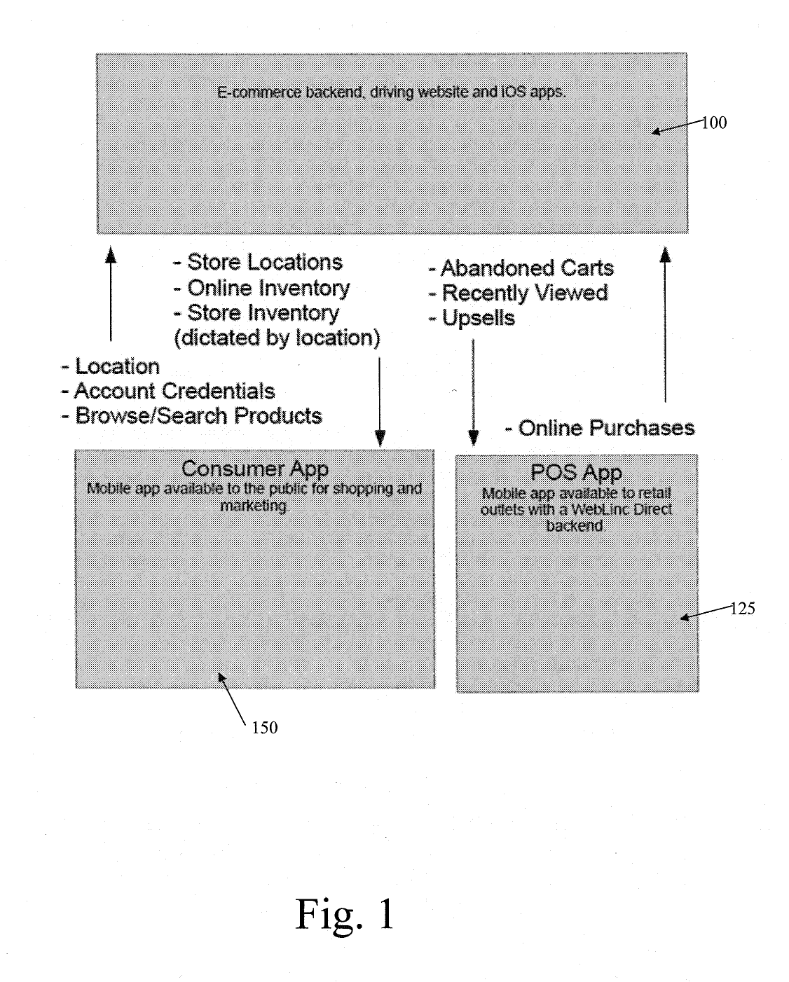

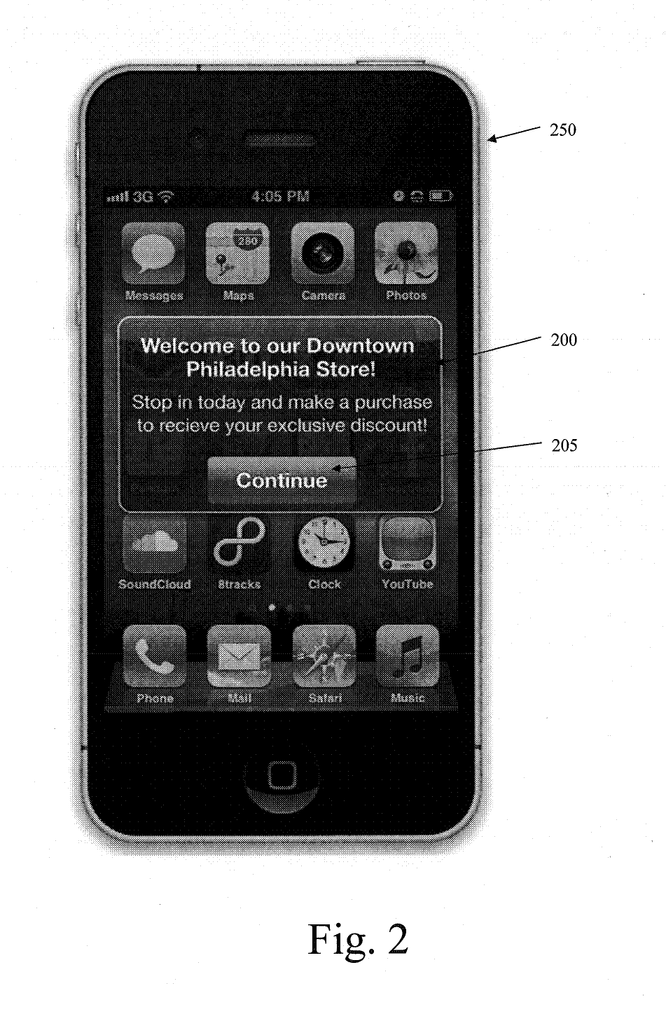

Referring to the drawings in detail, FIG. 1 is a system diagram of an integrated system having an E-Commerce platform 100, a mobile consumer application 150 and a point of sale application 125. The E-Commerce platform 100 tracks interactions of a shopper with a retailer's E-Commerce presence, through a website, mobile application, or the like. A shopper accesses a retailer's E-Commerce presence using a computing device over a network. Preferably, the network is the Internet, and the E-Commerce presence is a website or mobile application of a retailer. A retailer's mobile application is preferably accessible through a mobile device 250 (FIG. 2) such as a Smartphone or tablet computer.

Preferably, the E-Commerce platform 100 is implemented on one or more E-Commerce servers and includes a database of shopper profiles. Customer profiles are preferably stored in the database. In one embodiment, a unique shopper profile is created for each individual that accesses the E-Commerce platform 100 of the retailer, regardless whether the individual is registered as a shopper with the retailer or not For unregistered users, individuals may be tracked based on a unique IP Address, MAC address, or the like. Registered users are preferably tracked based on login information such as an email address or username.

Interactions tracked by the E-Commerce platform 100 include, but are not limited to, viewed items, items placed into a shopping cart, favorite items, purchased items, items added to a wish-list and items in viewed categories. Such interactions are preferably stored in the shopper's shopper profile so that the information is accessible each time the shopper visits the E-Commerce presence of the retailer.

The shopper profiles aggregated by the E-Commerce presence are accessible to devices located at points of sale in brick and mortar locations associated with the E-Commerce presence. A brick and mortar presence may be any type of store location having one or more points of sale and inventory on hand. Referring back to FIG. 1, point of sale (POS) devices include Point of Sale applications 125 that interact with the E-Commerce platform 100 to exchange information about shoppers, inventory, sales, and the like. Similarly, customers may download a consumer application 150 that interacts with both the E-Commerce platform 100 and the Point of Sale applications 125. The E-Commerce platform 100 is preferably an E-Commerce back-end that drives a retail website and mobile application. The point of sale application 125 is preferably a mobile application that is available only to staff and management of a retail location associated with a retailer having a compatible E-Commerce platform 100.

The consumer application 150 is preferably available to any customer through an application store such as the APPLE APP STORE, GOOGLE PLAY, AMAZON APP STORE, and the like. Thus, the consumer application 150 may be executed on a plurality of computing devices of consumers. In one preferred embodiment, the mobile computing device is an APPLE IPHONE. However, the consumer application 150 is not limited to being executable on any one particular platform, but instead is preferably adapted to function on a plurality of different platforms.

Preferably, the consumer application 150 communicates with the E-Commerce platform 100 via a network such as the Internet. Even more preferably, where the consumer application 150 is installed on a mobile device, a wireless network such as 802.11 WiFi or a 3G/4G broadband cellular network is provided to transmit communications (e.g., IP packets) between the consumer application 150 on the mobile device and the E-Commerce platform 100. Thus, the consumer application 150 may wirelessly communicate with the E-Commerce platform 100 while the customer is physically located at the brick and mortar location of the retailer.

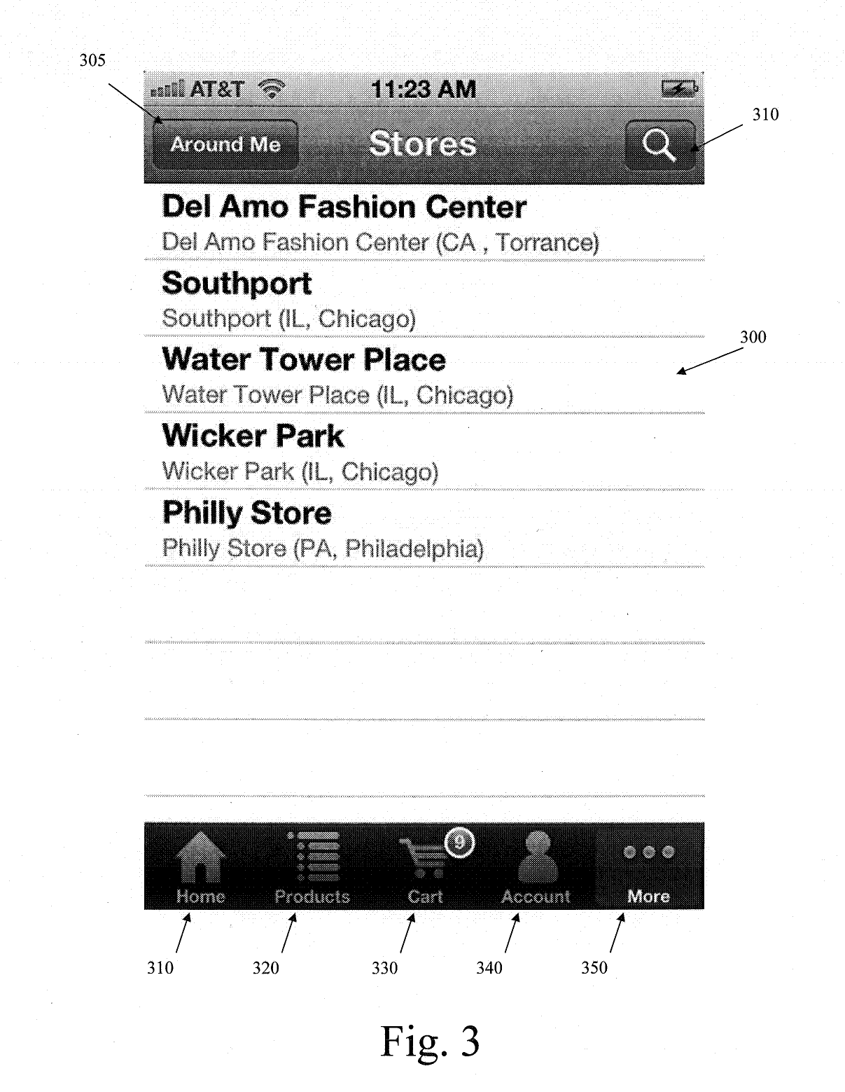

Examples of communications transmitted from the consumer application 150 to the E-Commerce platform 100 include a geographic location of the user, determined based on a geolocation of the mobile device executing the consumer application 150. In response, the E-Commerce platform 100 transmits store location information. Referring to FIG. 3, the consumer application 150 presents a list of retail locations 300. When a user clicks the AROUND ME button 305, the list of retail locations 300 is returned such that it is preferably sorted based on distance from the current location of the mobile device. A user may also search for particular retail locations 300 by pressing the search button 305. Preferably, the store location information is sorted based on distance from the user's geographic location. Account credentials of a customer associated with the mobile device 250 are transmitted from the consumer application 150 to the E-Commerce platform 100. Further, the customer may search for or browse through products available through the E-Commerce platform 100 using the consumer application 150. The E-Commerce platform 100 further provides inventory of items available through the E-Commerce platform 100. The E-Commerce platform 100 also provides inventory of items available at brick and mortar locations.

Communications between the Point of Sale applications 125 and the E-Commerce platform 100 include information about recently abandoned shopping carts, recently viewed items, upsells, and the like, being transmitted from the E-Commerce platform 100 to the Point of Sale applications 125. Online purchase information for items purchased at the brick and mortar location, for example, for items that are not available in the store's inventory, are transmitted from the Point of Sale applications 125 to the E-Commerce platform 100.

Preferably, when the consumer application 150 determines a geographic location of a mobile device 250 that is executing the consumer application 150. Methods of determining a geographic location of a mobile device 250 are well known to those skilled in the art and are not described herein for sake of brevity. Referring to FIG. 2, when the E-Commerce platform 100 determines that a user is proximate to a retailer's brick and mortar location (e.g., by comparing the user's geolocation to a database of brick and mortar locations), the E-Commerce platform 100 and Point of Sale application 125 may provide promotions to the user through a push notification 200. Thus, for example, when the user is determined to be within 500 feet of the store, the push notification 200 may be transmitted to the customer's mobile device 250 through the consumer application 150 alerting the customer of the available promotion. Preferably, the promotions presented to a particular user are selected based on the user's previous interactions with the E-Commerce platform 100, such as through a website or the consumer application 150, and are based on inventory of goods on hand at the location. The user may view the promotion by clicking a CONTINUE button 205 to launch the consumer application 150.

The promotions may be provided to customers when customers log in to their shopper profiles, so that the previous interaction data stored in the shopper profile is available. A user logs in by providing his or her login credentials to the consumer application 150, which transmits the login credentials to the E-Commerce platform 100. Once the user has logged in as a customer, the customer may be identified by the E-Commerce platform 100 any time the customer is geographically proximate to the retailer's brick and mortar location.

The consumer application 150 will now be described in more detail referring to FIGS. 3-9. Referring to FIG. 3, the consumer application 150 preferably includes a plurality of screens. A home screen 310 provides recommendations to the customer. A products screen 320 allows the customer to browse and search for products sold by the retailer. A Cart screen 330 provides a shopping cart for purchases through the retailer's E-Commerce platform 100. An account screen 340 allows the customer to manage the customer's account settings such as billing address, shipping address, payment information, and the like. The Account screen 340 also preferably allows the customer to manage privacy settings, as is known to those skilled in the art. Finally, a More screen 350 provides miscellaneous information relevant to the retailer, such as the store locations screen 300.

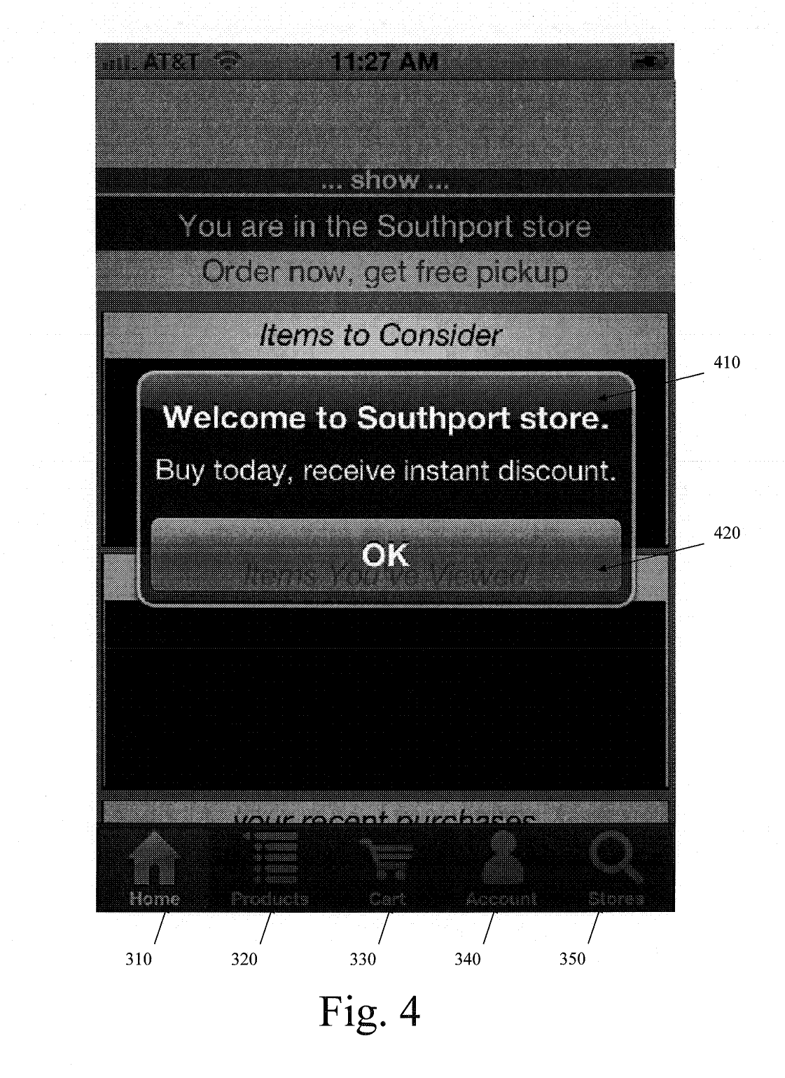

Location-specific promotions may be presented to a user once the user is associated with a brick and mortar location. A user may be associated with a location by, for example, checking into a retail location by In one embodiment, the user may select a store from the locations list 300 in the mobile application 150. More preferably, the E-Commerce platform 100 automatically associates the user with a location based on the determined geographic location of the user. Once the user is associated with the location, referring to FIG. 4, one or more location-specific promotions may be presented to the customer through the consumer application 150. The promotion may be presented by a push notification 410. The user may activate the promotion by pressing the OK button 420.

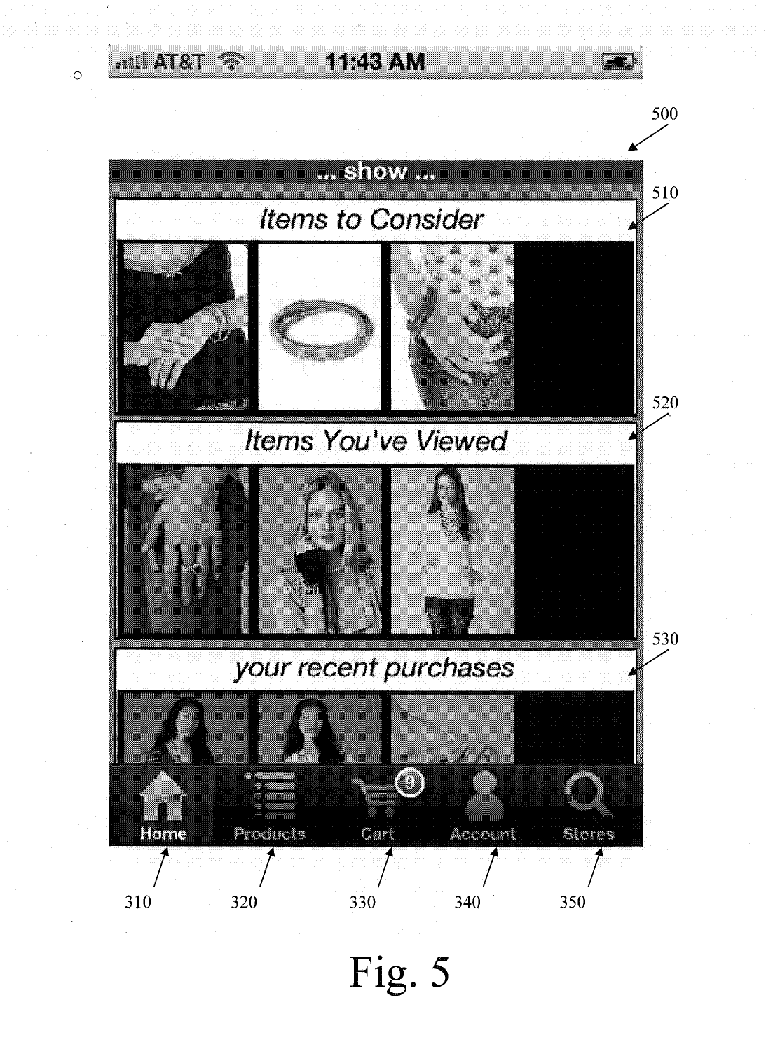

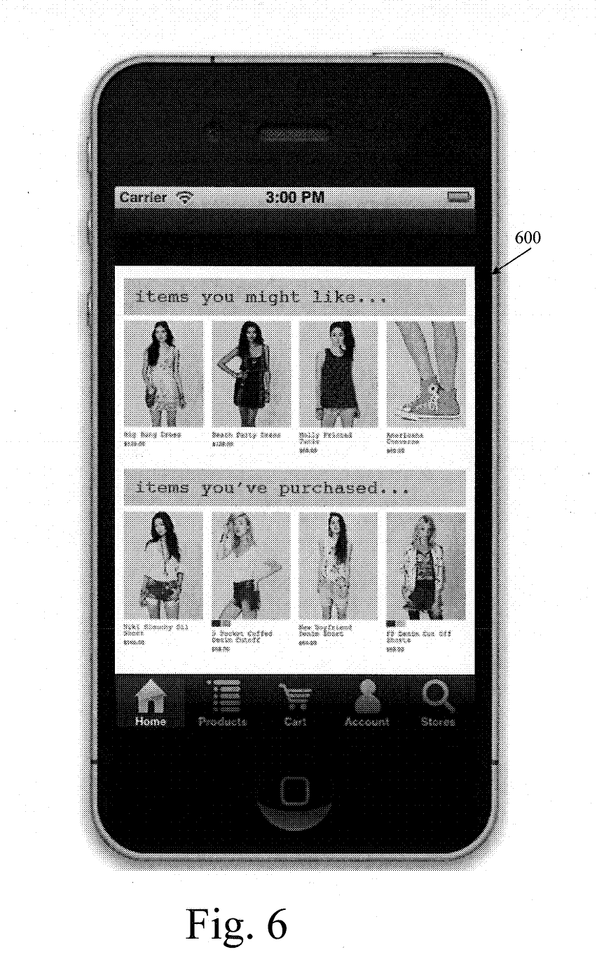

In a preferred embodiment, the promotions to be provided to the customer are dependent on the inventory levels of the brick and mortar location at which the customer is present. Thus, the user interaction data may be compared with the store's inventory. Referring to FIGS. 5 and 6, the consumer application 150 may notify the customer if their last several items viewed, items added to their online shopping cart but not purchased, items from last several categories browsed, items saved as favorites, and items added to a wish-list are available in the store at which the customer is present.

Referring to FIG. 5, a home screen 500 according to a first embodiment of the present invention is shown. The home screen 500 presents various types of information to the customer, including items the customer may want to consider purchasing 510, items the customer has viewed 520, and items recently purchased by the customer 530. Preferably, when the customer is associated with a retail location (e.g., when the customer is in a retail store), the items presented on the home screen 500 are filtered to display only items that are available for purchase in the retail location. In another embodiment, only the items the customer may want to consider purchasing and items the customer has viewed are filtered based on the location's inventory, while the recently purchased items are not so filtered. The items are presented in a visual fashion by, for example, showing a thumbnail image of the item. In an alternate embodiment, referring to FIG. 6, a home screen 600 may present items in a visual fashion by showing a thumbnail image together with a short textual description of the item.

Discounts or promotional prices may be offered based on online activity of the customer and current inventory in that particular location. Thus, for example, if the customer is interested in a sweater that is overstocked at the store, a discount may be offered through the consumer application 150 for the customer to purchase the sweater while at the brick and mortar location of the retailer. The consumer application 150 preferably suggests items in the store based on the customer's purchasing habits. Promotions may be offered to customers based on previous purchase history, such as, a discount that is provided to the retailer's best customers. Various other promotions, both dependent on and independent from the location's inventory may be provided to a customer without departing from the scope of this invention.

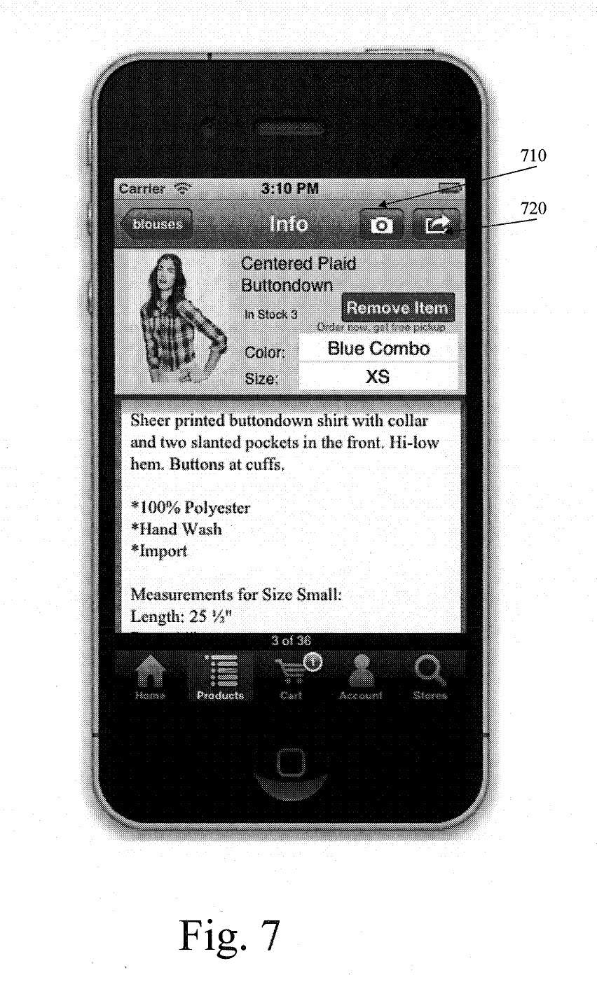

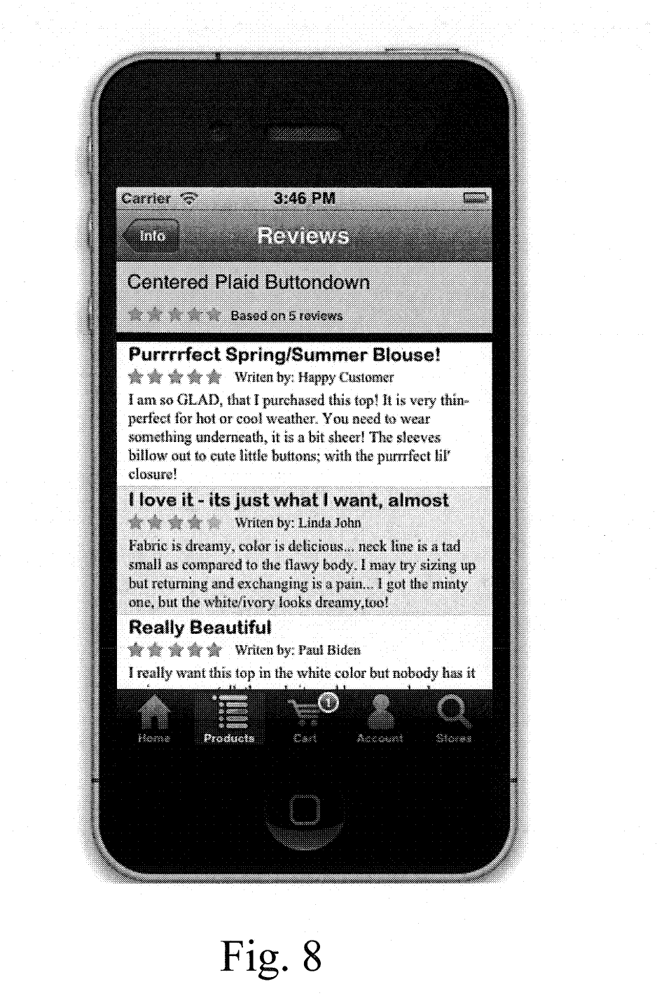

Referring to FIGS. 7 and 8, the consumer application 150 may be used for further product research and sharing on social networks. Typically, items at a retail store have tags with barcodes. As shown in FIG. 7, the consumer application 150 preferably includes a camera function 710 that uses a camera of the executing mobile device to “scan” the barcode of an item in the store. The barcode is decoded, and the customer may then review product information, check the E-Commerce platform 100 for inventory information, other colors or sizes of the product, availability through the E-Commerce presence of the retailer. As shown in FIG. 8, the customer may also view textual and rating-based product reviews for a particular product. In another embodiment, the customer may create outfits or collections using related products based on the scanned item.

If desired, the customer may add the scanned item to an online shopping cart for purchase through the E-Commerce platform 100. If the customer wishes to purchase an item through the retailer's E-Commerce presence, the consumer application 150 allows the customer to execute online purchases. Thus, the customer may identify items they like in the store, and purchase those items through the E-Commerce presence if the store's inventory does not include the right size or color for the customer.

The point of sale application 125 allows salespeople and management to view shopper profiles of customers currently visiting the retail location. Thus, when a customer enters a store, salespeople may tailor their service based on the customer's previous shopping history. Salespeople may view a customer's saved shopping carts, recently viewed items and outfits. The point of sale application 125 also allows salespeople to complete transactions with customers on the spot. A customer account may be created through the point of sale application 125. If a customer wishes to purchase an item that is unavailable in the store, the salesperson may use the point of sale application 125 to complete a transaction through the E-Commerce platform 100.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method of integrating a retailer's E-Commerce and Point of Sale presences, the method comprising:
populating, by a first server, a database of shopper profiles corresponding to a plurality of shoppers, each shopper profile corresponding to one or more shoppers accessing the retailer's E-Commerce presence over a first network;
identifying a geolocation of a first mobile device having an application that is associated with the retailer, the mobile device associated with a first shopper from the plurality of shoppers;
determining, by a second server, that the first shopper is geographically proximate to a brick and mortar presence associated with the retailer based on the identified geolocation; and
selecting a promotion for the first customer redeemable while the first customer is at the retailer's brick and mortar presence, wherein the promotion is selected based on in-store inventory; and
transmitting, by a third server, the selected promotion to the mobile device of the first customer over a second network.

2. The method of claim 1, wherein the first network and the second network are the Internet

3. The method of claim 1, wherein at least two of the first server, the second server and the third server are the same server.

4. The method of claim 1, wherein the promotion is selected based on an in-store inventory of the brick and mortar presence.
